(19) United States
(12) Patent Application Publication
(10) Pub. No.: US 2020/0401561 A1
(43) Pub. Date: Dec. 24, 2020

(54) METHOD, DEVICE, AND COMPUTER PROGRAM PRODUCT FOR MANAGING DATA OBJECT

(71) Applicant: EMC IP Holding Company LLC, Hopkinton, MA (US)

(72) Inventors: Simon Yuting Zhang, Chengdu (CN); Yizhou Zhou, Chengdu (CN)

(21) Appl. No.: 16/722,548

(22) Filed: Dec. 20, 2019

(30) Foreign Application Priority Data
Jun. 21, 2019 (CN) 201910541410.X

(51) Int. Cl. G06F 16/182; G06F 16/18; G06F 16/16; H04L 9/06

(52) U.S. Cl. CPC G06F 16/1844; H04L 9/0637; G06F 16/164; G06F 16/1865

(57) ABSTRACT

The present disclosure relates to a method, device and computer program product for managing a data object. In the method for managing a data object, a copy request for obtaining a copy of the data object is received from a requestor application system. At least one copy record associated with the data object is obtained from a group of copy records comprised in a copy blockchain associated with the data object. The number of copies of the data object is determined based on the at least one copy record. The copy request is handled based on the determined number of the copies. By means of immutable copy records comprised in the copy blockchain, the data object can be prevented from being illegally copied, and then higher security can be provided. Further, there is provided a device and computer program product for managing a data object.

### FIELD

Various implementations of the present disclosure relate to data storage, and more specifically, to a method, device and computer program product for managing copies of a data object in an application environment.

### BACKGROUND

With the development of data storage technologies, varieties of distributed storage systems have been developed, and various techniques for improving the data protection level have emerged. For purposes of data use, data security or others, multiple copies of a data object may exist in multiple application systems under an application environment, and a requestor application system may copy the data object from an owner application system where the data object is stored so as to generate a new copy. Therefore, how to manage the data object in a more reliable and effective way becomes a focus of research.

### SUMMARY

Therefore, it is desirable to develop and implement a technical solution for managing a data object more effectively. It is desired that the technical solution can be compatible with an existing processing system and manage a data object in the storage system more effectively by reconstructing configurations of the existing storage system.

According to a first aspect of the present disclosure, there is provided a method for managing a data object. In the method, a copy request for obtaining a copy of the data object is received from a requestor application system. At least one copy record associated with the data object is obtained from a group of copy records comprised in a copy blockchain associated with the data object. The number of copies of the data object is determined based on the at least one copy record. The copy request is handled based on the determined number of the copies.

According to a second aspect of the present disclosure, there is provided a device for managing a data object. The device comprises: at least one processing unit; at least one memory coupled to the at least one processing unit and having instructions stored thereon for being executed by the at least one processing unit, the instructions, when executed by the at least one processing unit, causing the device to perform acts. The acts include: receiving from a requestor application system a copy request for obtaining a copy of the data object; obtaining at least one copy record associated with the data object from a group of copy records comprised in a copy blockchain associated with the data object; determining the number of copies of the data object based on the at least one copy record; and handling the copy request based on the determined number of the copies.

According to a third aspect of the present disclosure, there is provided a computer program product. The computer program product is tangibly stored on a non-transient computer readable medium and comprises machine executable instructions which are used to implement a method according to the first aspect of the present disclosure.

### BRIEF DESCRIPTION OF THE DRAWINGS

Through the more detailed description in the accompanying drawings, features, advantages and other aspects of the implementations of the present disclosure will become more apparent. Several implementations of the present disclosure are illustrated schematically and are not intended to limit the present invention. In the drawings:

FIG. 1 schematically illustrates a block diagram of the process for managing a data object according to one technical solution;

FIG. 2 schematically illustrates a block diagram of the process for managing a data object according to example implementations of the present disclosure;

FIG. 3 schematically illustrates a flowchart of a method for managing a data object according to example implementations of the present disclosure;

FIG. 4 schematically illustrates a block diagram of a copy blockchain according to example implementations of the present disclosure;

FIG. 5 schematically illustrates a block diagram of the process for executing a copy request according to example implementations of the present disclosure;

FIG. 6 schematically illustrates a block diagram of a metadata blockchain according to example implementations of the present disclosure;

FIG. 7 schematically illustrates a block diagram of the process for returning a data object to a requestor application system that sends a copy request according to example implementations of the present disclosure; and

FIG. 8 schematically illustrates a block diagram of a device for managing a data object according to example implementations of the present disclosure.

### DETAILED DESCRIPTION OF IMPLEMENTATIONS

The preferred implementations of the present disclosure will be described in more details with reference to the drawings. Although the drawings illustrate the preferred implementations of the present disclosure, it should be appreciated that the present disclosure can be implemented in various manners and should not be limited to the implementations explained herein. On the contrary, the implementations are provided to make the present disclosure more thorough and complete and to fully convey the scope of the present disclosure to those skilled in the art.

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The terms “one example implementation” and “one implementation” are to be read as “at least one example implementation.” The term “a further implementation” is to be read as “at least a further implementation.” The terms “first”, “second” and so on can refer to same or different objects. The following text also can comprise other explicit and implicit definitions.

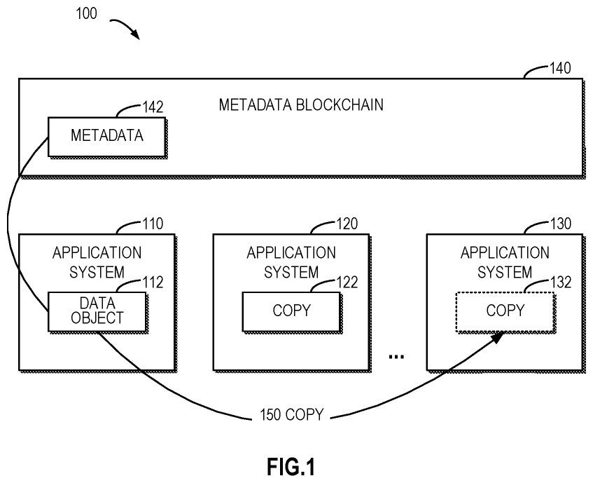

Technical solutions for data protection have been focusing on managing data objects in a more reliable way. An application environment has emerged in which multiple copies of a data object exist. In the application environment, as the number of copies of the data object increase constantly, the data object may be managed with the aid of a copy data management (CDM) program. CDM may make multiple copies of the data object according to a predefined rule. With the development of distributed storage technologies, multiple copies might be distributed in application systems of various data centers in the world. This greatly increases the risk that the data object might be attacked. There have been provided technical solutions for increasing the data security. With reference to FIG. 1, a brief description is presented below to the process for managing a data object according to existing technical solutions.

FIG. 1 schematically shows a block diagram 100 of the process for managing a data object 112 according to one technical solution. As depicted, there has been proposed a technical solution for preventing hackers or malware from tampering with data based on blockchain technology. FIG. 1 schematically shows multiple application systems, such as an application system 110 in which a data object 112 is stored, and an application system 120 in which a copy 122 of the data object 112 is stored. It will be understood here the data object 112 and the copy 122 have the same content. Hereinafter, the copy of the data object 112 may be referred to as a copy, and the data object 112 and the copy 122 may denote the same meaning. For example, the number of copies of a data object in an application environment may denote the total number of the data object and the copies.

Here the data object 112 may comprise user data. For example, the data object 112 may be a text file, image, picture, video and other file type. For example, the data object 112 may further comprise images of an operating system and an application system at the application system 110. In order to guarantee the reliability of data or for the purpose of sharing data, backup operations may be performed to the application system at different time points, so as to form the copy 122 in other application system (e.g. application system 120).

It will be understood while application systems are running, they might be attacked by hackers, malware and/or others. For example, malware might tamper with content of the data object 112, so that the data object 112 becomes inconsistent with initial raw data. On the other hand, since vendors of the application system 110 and 120 also might tamper with data stored therein, users do not completely trust vendors of the application systems 110 and 120. At this point, for example, when an application system 130 sends a copy request to the application systems 110, 120 that have the data object 112 or the copy 122, the data object 112 and the copy 122 in the application systems 110 and 120 might have been tampered with. Thus, if a copy operation is performed directly, then the object which has been tampered with will be sent to the application system 130.

In order to guarantee the integrity of data, there has been proposed a technical solution for verifying whether the data object 112 and its copy 122 have been tampered with based on metadata 142. In the technical solution, metadata 142 of the data object 112 may be generated and then sent to a metadata blockchain 140. Since the metadata blockchain 140 is immutable, the metadata 142 will not be modified by malware.

During a copy operation, new metadata may be generated based on the data object 112, and by comparing the newly generated metadata with the metadata 142, it may be determined whether the data object 112 has been tampered with. If the two metadata are consistent with each other, this means the data object 112 is trusted and is not modified. If the two metadata are inconsistent with each other, this means the data object 112 is untrusted and has been modified. If the data object 112 is not tampered with, then it may be copied (as shown by an arrow 150) from the application system 110 to the application system 130 so as to generate a copy 132.

It will be understood although FIG. 1 depicts only one data object 112 and its copy 122, there may exist more data objects and copies in real application environments. Further, the metadata blockchain 140 may comprise metadata of more data objects. Although the above approach may verify whether the data object 112 is tampered with, malware or hackers might steal data that cannot be copied through illegal copy operations. Suppose the maximum number of copies of the data object 112 which are allowed in the application environment is 2, at this point the data object 112 and the copy 122 as shown in FIG. 1 reach the maximum number 2, so the operation that the application system 130 requests to copy the data object 112 will be construed as an illegal operation. However, by changing the maximum number to 3 or changing the number of existing copies of the data object to 1, malware or hackers may trick the application system 110 and perform the copy operation as shown by the arrow 150. Thus, it is desirable to manage the data object more securely and reliably, so as to prohibit illegal copy operations.

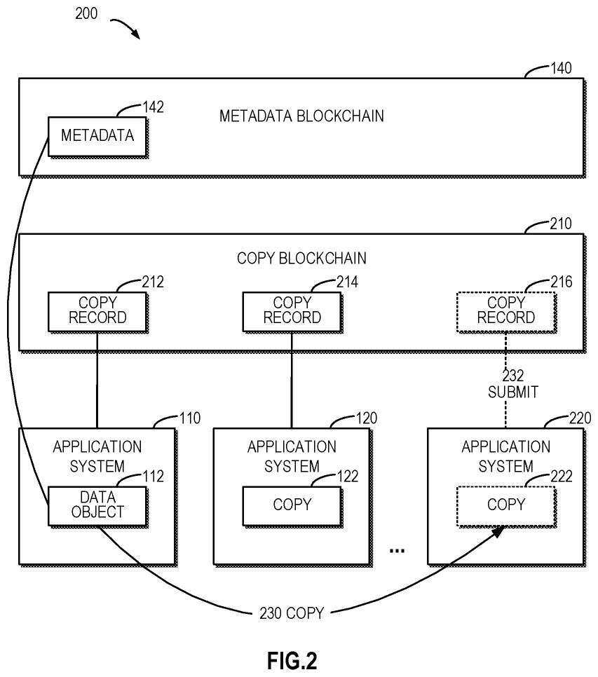

To solve the above drawbacks, implementations of the present disclosure provides a method, device and computer program product for managing a data object According to example implementations of the present disclosure, the concept of copy blockchain is introduced, and information related to historical copy transactions of executing the data object 112 may be stored in the copy blockchain. More details about implementations of the present disclosure will be described with reference to FIG. 2 below.

FIG. 2 schematically shows a block diagram 200 of the process for managing a data object according to example implementations of the present disclosure. As depicted, a copy blockchain 210 may comprise copy records associated with copying the data object 112. A copy record 212 may comprise various information associated with the data object 112, e.g. which one of copies in the application environment the data object 112 is, the maximum number of copies allowed for the data object 112, etc. Similarly, a copy record 214 may comprise various information associated with the copy 122. At this point, the copy blockchain 210 already comprises a copy record related to each copy. Since the copy blockchain 210 is immutable, malware or hackers may be prevented from illegally tampering with the allowed maximum number and/or the number of existing copies in the application environment.

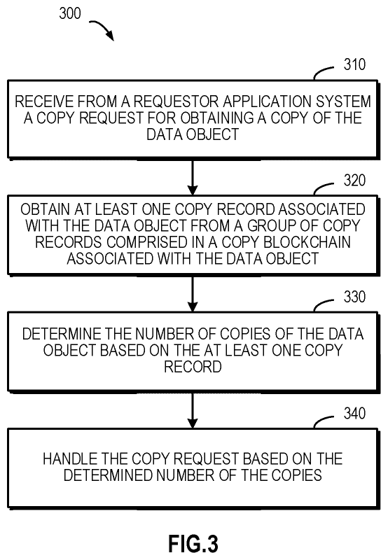

As shown in FIG. 2, when an application system 220 wants to perform copying, the owner application system 110 owning the data object 112 may query copy records in the copy blockchain 210 so as to determine the number of existing copies of the data object. If the number of existing copies is lower than the maximum number, then a copy operation as shown by an arrow 230 may be performed. With example implementations of the present disclosure, since the copy blockchain 210 is immutable, recording copy records on copy operations based on the copy blockchain 210 may increase the security of the data object and further reduce the risk of illegal copies. More details about implementations of the present disclosure will be described with reference to FIG. 3 below.

FIG. 3 schematically shows a flowchart of a method 300 for managing a data object according to example implementations of the present disclosure. At block 310, a copy request for obtaining a copy of the data object 112 may be received from the application system 220 acting as a requestor. It will be understood here the copy request is a copy request which is sent by the requestor, which wants to obtain the data object, to the owner application system 110 in which the data object 112 is stored, and the method 300 may be performed at the application system 110 acting as an owner.

An owner list may be stored in the copy blockchain 210 or at other location in the application environment, and the requestor may query the owner list to find in which application system(s) copies of the data object 112 are stored. The requestor application system may select an owner application system to which the copy request is sent, based on factors such as a workload, bandwidth of the owner application system, a distance to the requestor application system, etc.

At block 320, at least one copy record associated with the data object is obtained from a group of copy records comprised in the copy blockchain 210 associated with the data object 112. Here, a search may be performed in the copy blockchain 210 based on an identifier of the data object 112 desired to be copied, so as to find all historical copy records associated with the data object 112. For example, regarding the example as shown in FIG. 2, the at least one copy record as found may comprise the copy record 212 and the copy record 214.

At block 330, the number of copies of the data object 112 is determined based on the at least one copy record. As described above, the copy record 212 and the copy record 214 are found at block 320, which means in the application environment there already exist 2 copies of the data object 112. At block 340, the copy request may be handled based on the determined number of the copies. It will be understood two circumstances will arise: (1) if the determined number of the copies is lower than the maximum number allowed for the data object, then the copy request is executed; and (2) if the determined number of the copies already reaches the maximum number allowed for the data object, then the copy request cannot be executed. With example implementations of the present disclosure, the maximum number may be stored in a copy record, other data structure of the copy blockchain 210, or other trusted storage device. Since copy records are stored in the immutable copy blockchain 210, at this point malware or hackers cannot tamper with the maximum number or the number of existing copies. In this way, the possibility that the data object 112 is copied illegally may be reduced.

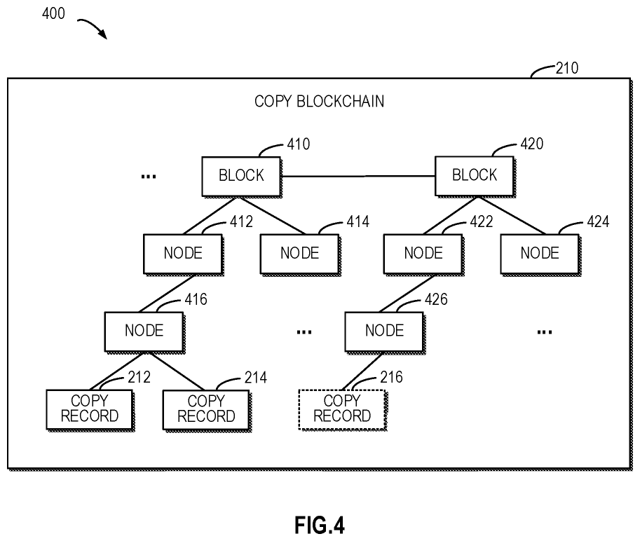

More details about the copy blockchain 210 will be described with reference to FIG. 4 below. This figure schematically shows a block diagram 400 of a structure of the copy blockchain 210 according to example implementations of the present disclosure. Here the copy blockchain 210 may comprise one or more copy records associated with the data object 112. For example, where there already exist the data object 112 and the copy 122 in the application environment, copy records may comprise the copy record 212 corresponding to the data object 112 and the copy record 214 corresponding to the copy 122, respectively.

According to example implementations of the present disclosure, a copy record among the one or more copy records may comprise a copy transaction for obtaining a copy of the data object 112. The copy transaction may comprise multiple copy-related attributes. In one example implementation, the copy transaction may be defined using a data structure as shown in Table 1 below.

TABLE 1
Example of Copy Transaction

| No. | Attribute | Description |
|---|---|---|
| 1 | Maximum | Maximum number of copies |
| | number | of a data object which are |
| | | allowed in the |
| | | application environment |
| 2 | Number of | Number of a current copy |
| | current copy | |

When the maximum number equals 3 and the copy transaction is represented by the data structure shown in Table 1, the maximum number in the copy record may be set to 3, and the number of a current copy may be set to 1, which means the data object 112 is the first copy of the data object; the maximum number in the copy record 214 may be set to 3, and the number of a current copy may be set to 2, which means the data object 112 is the second copy of the data object.

It will be understood the data structure in Table 1 above is merely schematic. According to example implementations of the present disclosure, the copy transaction may further be stored in other way. For example, the number of copies existing in the application environment may be replaced with the number of current copies. For another example, the copy transaction may further comprise more information associated with the copy operation. Table 2 schematically shows another example of the copy transaction.

TABLE 2
Example of Copy Transaction

| No. | Attribute | Description |
|---|---|---|
| 1 | Maximum | Maximum number of copies |
| | number | of the data object |
| | | which are |
| | | allowed in the |
| | | application environment |
| 2 | Number of | Number of a current copy |
| | current copy | |
| 3 | Public | Public key related to |
| | key | encryption/decryption |
| | | operations involved in |
| | | the copy |
| 4 | Owner | From which owner |
| | | application system |
| | | a current copy is |
| | | obtained |
| 5 | Metadata | ID of metadata of abstract |
| | ID | information comprising a |
| | | current copy |
| 6 | Previous | Previous copy transaction |
| | transaction | associated with a current |
| | | copy transaction |
| 7 | Signature | Digital signature of a |
| | | current copy transaction |
| . . . | . . . | |

It will be understood Table 2 merely shows an example of a usable data structure. During specific running, the copy transaction may comprise more or less entries than Table 2. For example, the copy transaction may further comprise a submit time. According to example implementations of the present disclosure, a copy record in the copy blockchain 210 is added to the copy blockchain 210 in response to a historical copy transaction submitted by the application system. For example, the copy record 214 is submitted by the application system 120 to the copy blockchain 210 for the purpose of obtaining the copy 122.

According to example implementations of the present disclosure, multiple copy records may be appended to blocks in the copy blockchain 210. As shown in FIG. 4, a node 416 may be generated based on abstracts of the copy records 212 and 214, and an upper node may be generated based on information of lower nodes. For example, a node 412 is generated based on a child node 416 of the node 412 and other child node, and a block 410 is generated based on nodes 412 and 414.

According to example implementations of the present disclosure, when it is determined the number “2” of existing copies is lower than the maximum number “3,” the requestor application system 220 may be notified to submit the obtained copy record 216 associated with copies of the data object to the copy blockchain 210. Returning to FIG. 2, as shown by a dotted line 232 in FIG. 2, in order to obtain copies of the data object 112, the application system 220 may submit the copy record 216 to the copy blockchain 210. The copy record 216 submitted by the application system 220 may be appended to the copy blockchain 210. At this point, a node 426 is generated based on the copy record 216 and other child nodes of the node 426, and a node 422 is generated based on the node 426 and other child nodes of the node 422. A block 420 is generated based on nodes 422 and 424.

It will be understood although FIG. 4 schematically shows copy records associated with the data object 112 only, according to example implementations of the present disclosure, the copy blockchain 210 may further comprise copy records associated with one or more data objects. Thus, the copy blockchain 210 stores a copy history associated with a number of data objects in an immutable way. By looking up copy records associated with the data object 112 in the copy blockchain 210, the number of existing copies and the allowed maximum number in the application environment may be determined accurately. Further, only when it is determined the number of existing copies is lower than the maximum number, a copy operation is allowed, and illegal copying may be avoided.

The owner application system 110 may check the copy blockchain 210 so as to determine whether the copy record 216 submitted by the requestor application system already exists in the copy blockchain 210 or not. If the copy record 216 associated with the copy transaction is obtained from the copy blockchain 210, it proves the copy blockchain 210 already includes an immutable copy transaction about a to-be-performed copy, so the data object 112 may be transmitted to the requestor application system 220.

With example implementations of the present disclosure, it may be guaranteed a copy transaction associated with each copy operation is recorded in the copy blockchain 210. By performing a relevant copy operation only when the copy transaction is recorded, it may be guaranteed the number of copies in multiple application systems is always not higher than the maximum number, and further the risk of illegal copy may be reduced.

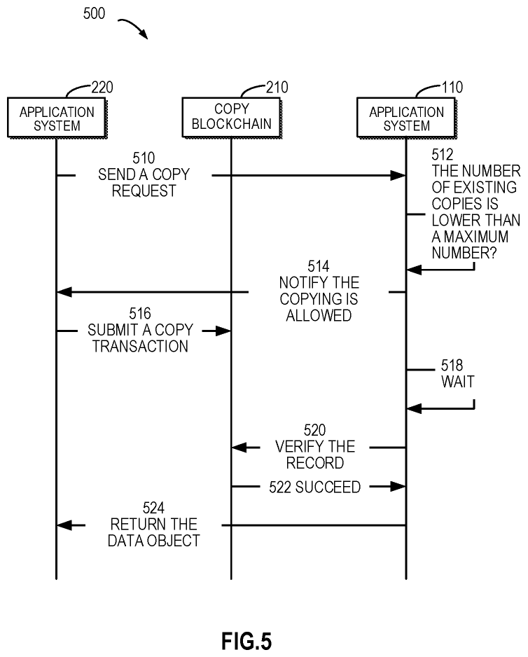

According to example implementations of the present disclosure, there might be latency in the process of the requestor application system 110 submitting the copy record 216. Thus, the copy blockchain 210 may be checked periodically so as to determine whether the copy record 216 has been submitted. If the copy record 216 associated with the copy transaction is not obtained from the copy blockchain 210, a predetermined time interval is waited. Subsequently, the copy record 216 associated with the copy transaction may be re-obtained from the copy blockchain 210. With reference to FIG. 5, description is presented below to more details on how to perform a copy request based on the copy blockchain 210.

FIG. 5 schematically shows a block diagram 500 of the process for performing a copy request according to example implementations of the present disclosure. As shown by an arrow 510 in FIG. 5, the application system 220 that wants to obtain a copy of a data object sends a copy request to the application system 110 where the data object is stored. At this point, the application system 110 may determine, based on the copy blockchain 210, whether the number of existing copies is lower than the maximum number or not. If yes, then the application system 110 may notify the application system 220 to allow a copy operation (as shown by an arrow 514).

At 516, the application system 220 may submit a copy record to the copy blockchain 210. As shown by an arrow 518, the application system 110 may wait a predetermined time interval, and verify at 520 whether in the copy blockchain 210 there exists a copy task submitted by the application system 220. If the verification succeeds at an arrow 522, the application system 110 may return the requested data object to the application system 220 (as shown by an arrow 524).

While returning the data object to the application system 220, it may be verified based on the metadata blockchain 140 whether the data object 112 in the owner application system 110 has been tampered with. Further, only where the data object is not tampered with, the data object 112 is copied to the requestor application system 220. Specifically, at the owner application system 110, metadata comprising abstract information of the data object 112 may be generated based on the data object 112.

Here it is not intended to limit how the abstract information of the data object is generated. As demanded by a specific application environment, the abstract information of the data object may be generated in various manners. According to example implementations of the present disclosure, the abstract information may be generated based on algorithms such as MD5, SHA1, SHA256, CRC, etc. It will be understood besides the above abstract information, the generated metadata may further comprise other information, such as a file structure, attributes, access information, and a checksum associated with the data object.

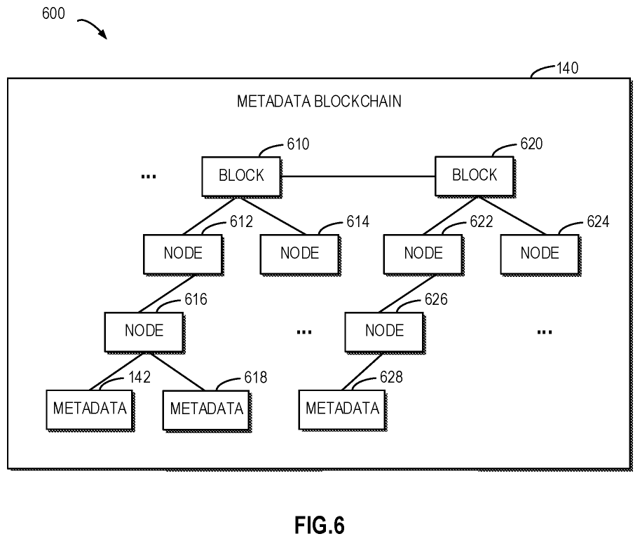

Metadata 142 associated with the data object 112 may be obtained from the metadata blockchain 140 associated with the data object 112. It will be understood here the metadata 142 is pre-stored in the metadata blockchain 140 and serves a purpose of verifying whether the data object 112 has been tampered with. According to example implementations of the present disclosure, a detailed description is presented to more details about the metadata blockchain 140 with reference to FIG. 6. This figure schematically shows a block diagram 600 of a structure of the metadata blockchain 140 according to example implementations of the present disclosure.

As shown in FIG. 6, the metadata blockchain 140 may comprise metadata of multiple data objects, e.g. the metadata 142 of the data object 112, and metadata 618 and 628 of other data objects. Blocks 610 and 620 are generated based on metadata stored to the metadata blockchain 140 at different time periods. For example, the block 610 may be generated based on multiple metadata stored to the metadata blockchain 140 at an earlier time, and the block 620 may be generated based on multiple metadata stored to the metadata blockchain 140 later.

The metadata blockchain 140 is generated hierarchically. For example, a node 616 is generated based on the metadata 142 and the metadata 618, a node 612 is generated based on a node 616 and other child nodes of the node 612, and the block 610 is generated based on the node 612 and a node 614. Similarly, a node 626 is generated based on the metadata 628 and other child nodes of the node 626, a node 622 is generated based on the node 626 and other child nodes of the node 622, and the block 620 is generated based on the node 622 and a node 624.

In FIG. 6, the metadata 142 may be stored to the metadata blockchain 140 at different time points, e.g. the metadata 142 may be generated at any time point after content of the data object 112 is fixed, and may be stored to the metadata blockchain 140. The way the metadata 142 is generated here is the same as that described above, for example, abstract information may be generated based on algorithms such as MD5, SHA1, SHA256 and CRC. Similarly, besides the above abstract information, the generated metadata may comprise other information, such as a file structure, attributes, access information and a checksum associated with the data object. If it is determined the generated metadata matches the metadata 142 obtained from the metadata blockchain 140, the data object is transmitted to the requestor application system 220.

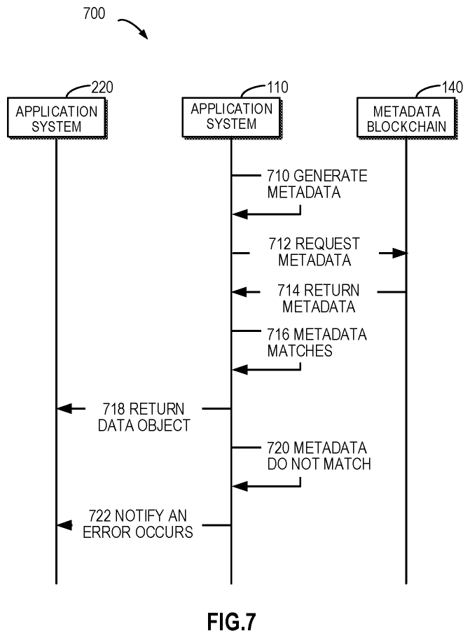

According to example implementations of the present disclosure, if it is determined the generated metadata does not match the metadata 142, this means the data object 112 has been tampered with, and thus the requestor application system 220 may be notified that the data object 112 has been modified. Further, where it is found the data object 112 has been modified, the administrator of the application system 110 may be notified to check potential bugs, so as to reduce the potential risk that the application system 110 is attached. More details on how to return the data object to the application system 220 will be described with reference to FIG. 7 below.

FIG. 7 schematically shows a block diagram 700 of the process for returning a data object to an application system that sends a copy request according to example implementations of the present disclosure. At an arrow 710 in FIG. 7, the application system 110 may generate metadata based on the data object 112. As shown by an arrow 712, the application system 110 may further request corresponding metadata 142 from the metadata blockchain 140. At 714, the metadata blockchain 140 may return the requested metadata to the application system 110. Subsequently, the application system 110 may compare the generated metadata with the obtained metadata to see whether they match each other. As shown by an arrow 716, if the two metadata match, then at an arrow 718, the data object 112 in the application system 110 may be returned to the application system 220. As shown by an arrow 720, if the two metadata do not match, then at an arrow 722, the application system 220 may be notified that an error occurs to the application system 110.

According to example implementations of the present disclosure, where the data object 112 in the application system 110 has been modified, the copy request may be forwarded to a further owner application system where a copy of the data object 112 is stored. It will be understood since each application system operates independently, data in part of application systems among the multiple application systems might be tampered with, while data in other application systems are not tampered with. At this point, an application system where a data object which has not been tampered with may be requested to copy the data object to the requestor application system. For example, the application system 110 may send the copy request to the application system 120 so as to instruct the application system 120 to confirm whether the copy 122 has been modified.

If the copy 122 is not modified, then the application system 120 may copy the copy 122 to the application system 220 so as to form a copy 222 in the application system 220. According to example implementations of the present disclosure, the data object 112 in the application system 110 which has been tampered with may further be replaced with the copy 122 which is not tampered with. With example implementations of the present disclosure, on the one hand it may be guaranteed data sent to the requestor application system 220 is not tampered with, and on the other hand where data in the application system 110 is found to be tampered with, data tampered with may be replaced with original data which is not tampered with.

While examples of the method according to the present disclosure have been described in detail with reference to FIGS. 2 to 7, description is presented below to the implementation of a corresponding apparatus. According to example implementations of the present disclosure, provided is an apparatus for managing a data object. The apparatus comprises: a receiving module configured to receive from a requestor application system a copy request for obtaining a copy of the data object; an obtaining module configured to obtain at least one copy record associated with the data object from a group of copy records comprised in a copy blockchain associated with the data object; a determining module configured to determine the number of copies of the data object based on the at least one copy record; and a handling module configured to handle the copy request based on the determined number of the copies.

According to example implementations of the present disclosure, the handling module is further configured to: execute the copy request in response to the determined number of the copies being lower than an allowed maximum number for the data object.

According to example implementations of the present disclosure, the apparatus is implemented at an owner application system where the data object is stored.

According to example implementations of the present disclosure, the handling module is further configured to: notify the requestor application system to submit to the copy blockchain a copy record associated with obtaining a copy of the data object; and transmit the data object to the requestor application system in response to a copy record associated with a copy transaction being obtained from the copy blockchain.

According to example implementations of the present disclosure, the handling module is further configured to: wait a predetermined time interval in response to a copy record associated with the copy transaction not being obtained from the copy blockchain; and re-obtain a copy record associated with the copy transaction from the copy blockchain.

According to example implementations of the present disclosure, the handling module is further configured to: based on the data object, generate metadata comprising abstract information of the data object; obtain metadata associated with the data object from a metadata blockchain associated with the data object; and transmit the data object to the requestor application system in response to determining the generated metadata and the obtained metadata match each other.

According to example implementations of the present disclosure, the handling module is further configured to: in response to determining the generated metadata and the obtained metadata do not match each other, notify the requestor application system that the data object has been modified.

According to example implementations of the present disclosure, the handling module is further configured to: notify a further owner application system, where a copy of the data object is stored, to transmit the data object to the requestor application system.

According to example implementations of the present disclosure, a copy record of the at least one copy record comprises a copy transaction for obtaining a copy of the data object.

According to example implementations of the present disclosure, a copy record of the at least one copy record is added to the copy blockchain in response to a historical copy transaction submitted by an application system.

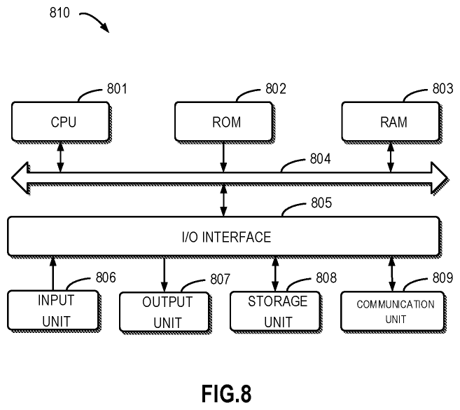

FIG. 8 schematically shows a block diagram of a device 800 for managing a data object according to example implementations of the present disclosure. As depicted, the device 800 includes a central process unit (CPU) 801, which can execute various suitable actions and processing based on the computer program instructions stored in the read-only memory (ROM) 802 or computer program instructions loaded in the random-access memory (RAM) 803 from a storage unit 808. The RAM 803 can also store all kinds of programs and data required by the operations of the apparatus 800. CPU 801, ROM 802 and RAM 803 are connected to each other via a bus 804. The input/output (I/O) interface 805 is also connected to the bus 804.

A plurality of components in the device 800 is connected to the I/O interface 805, including: an input unit 806, such as keyboard, mouse and the like; an output unit 807, e.g., various kinds of display and loudspeakers etc.; a storage unit 808, such as magnetic disk and optical disk etc.; and a communication unit 809, such as network card, modem, wireless transceiver and the like. The communication unit 809 allows the device 800 to exchange information/data with other devices via the computer network, such as Internet, and/or various telecommunication networks.

The above described each process and treatment, such as the method 300 can also be executed by the processing unit 801. For example, in some implementations, the method 300 can be implemented as a computer software program tangibly included in the machine-readable medium, e.g., the storage unit 808. In some implementations, the computer program can be partially or fully loaded and/or mounted to the device 800 via ROM 802 and/or the communication unit 809. When the computer program is loaded to the RAM 803 and executed by the CPU 801, one or more steps of the above described method 300 can be implemented. Alternatively, in other implementations, the CPU 801 also can be configured in other suitable manners to realize the above procedure/method.

According to example implementations of the present disclosure, there is provided a device for managing a data object. The device comprises: at least one processing unit; at least one memory coupled to the at least one processing unit and having instructions stored thereon for being executed by the at least one processing unit, the instructions, when executed by the at least one processing unit, causing the device to perform acts. The acts include: receiving from a requestor application system a copy request for obtaining a copy of the data object; obtaining at least one copy record associated with the data object from a group of copy records comprised in a copy blockchain associated with the data object; determining the number of copies of the data object based on the at least one copy record; and handling the copy request based on the determined number of the copies.

According to example implementations of the present disclosure, handling the copy request based on the determined number of the copies comprises: executing the copy request in response to the determined number of the copies being lower than an allowed maximum number for the data object.

According to example implementations of the present disclosure, the device is implemented at an owner application system where the data object is stored.

According to example implementations of the present disclosure, executing the copy request comprises: notifying the requestor application system to submit to the copy blockchain a copy record associated with obtaining a copy of the data object; and transmitting the data object to the requestor application system in response to a copy record associated with a copy transaction being obtained from the copy blockchain.

According to example implementations of the present disclosure, the acts further comprise: waiting a predetermined time interval in response to a copy record associated with the copy transaction not being obtained from the copy blockchain; and re-obtaining a copy record associated with the copy transaction from the copy blockchain.

According to example implementations of the present disclosure, transmitting the data object to the requestor application system comprises: based on the data object, generating metadata comprising abstract information of the data object; obtaining metadata associated with the data object from a metadata blockchain associated with the data object; and transmitting the data object to the requestor application system in response to determining the generated metadata and the obtained metadata match each other.

According to example implementations of the present disclosure, the acts further comprise: in response to determining the generated metadata and the obtained metadata do not match each other, notifying the requestor application system that the data object has been modified.

According to example implementations of the present disclosure, the acts further comprise: notifying a further owner application system, where a copy of the data object is stored, to transmit the data object to the requestor application system.

According to example implementations of the present disclosure, a copy record of the at least one copy record comprises a copy transaction for obtaining a copy of the data object.

According to example implementations of the present disclosure, a copy record of the at least one copy record is added to the copy blockchain in response to a historical copy transaction submitted by an application system.

According to example implementations of the present disclosure, there is provided a computer program product. The computer program product is tangibly stored on a non-transient computer readable medium and comprises machine executable instructions which are used to implement the method according to the present disclosure.

According to example implementations of the present disclosure, there is provided a computer readable medium. The computer readable medium has machine executable instructions stored thereon, the machine executable instructions, when executed by at least one processor, causing the at least one processor to implement the method according to the present disclosure.

The present disclosure can be method, device, system and/or computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but not limited to, such as electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can include copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages consist of object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider). In some implementations, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Various aspects of the present disclosure are described here with reference to flow chart and/or block diagram of method, apparatus (system) and computer program products according to implementations of the present disclosure. It should be understood that each block of the flow chart and/or block diagram and the combination of various blocks in the flow chart and/or block diagram can be implemented by computer-readable program instructions.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions contains an article of manufacture, including instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow chart and block diagram in the drawings illustrate system architecture, functions and operations that may be implemented by system, method and computer program product according to multiple implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various implementations of the present disclosure have been described above and the above description is only exemplary rather than exhaustive and is not limited to the implementations of the present disclosure. Many modifications and alterations, without deviating from the scope and spirit of the explained various implementations, are obvious for those skilled in the art. The selection of terms in the text aims to best explain principles and actual applications of each implementation and technical improvements made in the market by each implementation, or enable other ordinary skilled in the art to understand implementations of the present disclosure.

1. A method for managing a data object, the method comprising:
receiving from a requestor application system a copy request for obtaining a copy of the data object;
obtaining at least one copy record associated with the data object from a group of copy records comprised in a copy blockchain associated with the data object;
determining a number of copies of the data object based on the at least one copy record; and
handling the copy request based on the determined number of the copies.

2. The method of claim 1, wherein handling the copy request based on the determined number of the copies comprises:
executing the copy request in response to the determined number of the copies being lower than an allowed maximum number for the data object.

3. The method of claim 1, wherein the method is implemented at an owner application system where the data object is stored.

4. The method of claim 2, wherein executing the copy request comprises:
notifying the requestor application system to submit to the copy blockchain a copy record associated with obtaining a copy of the data object; and
transmitting the data object to the requestor application system in response to a copy record associated with a copy transaction being obtained from the copy blockchain.

5. The method of claim 4, further comprising:
waiting a predetermined time interval in response to a copy record associated with the copy transaction not being obtained from the copy blockchain; and
re-obtaining a copy record associated with the copy transaction from the copy blockchain.

6. The method of claim 4, wherein transmitting the data object to the requestor application system comprises:
generating metadata comprising abstract information of the data object based on the data object;
obtaining metadata associated with the data object from a metadata blockchain associated with the data object; and
transmitting the data object to the requestor application system in response to determining the generated metadata and the obtained metadata match each other.

7. The method of claim 6, further comprising:
in response to determining the generated metadata and the obtained metadata do not match each other, notifying the requestor application system that the data object has been modified.

8. The method of claim 7, further comprising:
notifying a further owner application system, where a copy of the data object is stored, to transmit the data object to the requestor application system.

9. The method of claim 1, wherein a copy record of the at least one copy record comprises a copy transaction for obtaining a copy of the data object.

10. The method of claim 9, wherein a copy record of the at least one copy record is added to the copy blockchain in response to a historical copy transaction submitted by an application system.

11. A device for managing a data object, comprising:
at least one processing unit;
at least one memory coupled to the at least one processing unit and having instructions stored thereon for being executed by the at least one processing unit, the instructions, when executed by the at least one processing unit, causing the device to perform operations, the operations comprising:
receiving from a requestor application system a copy request for obtaining a copy of the data object;
obtaining at least one copy record associated with the data object from a group of copy records comprised in a copy blockchain associated with the data object;
determining a number of copies of the data object based on the at least one copy record; and
handling the copy request based on the determined number of the copies.

12. The device of claim 11, wherein handling the copy request based on the determined number of the copies comprises:
executing the copy request in response to the determined number of the copies being lower than an allowed maximum number for the data object.

13. The device of claim 11, wherein the device is implemented at an owner application system where the data object is stored.

14. The device of claim 12, wherein executing the copy request comprises:
notifying the requestor application system to submit to the copy blockchain a copy record associated with obtaining a copy of the data object; and
transmitting the data object to the requestor application system in response to a copy record associated with a copy transaction being obtained from the copy blockchain.

15. The device of claim 14, wherein the operations further comprise:
waiting a predetermined time interval in response to a copy record associated with the copy transaction not being obtained from the copy blockchain; and
re-obtaining a copy record associated with the copy transaction from the copy blockchain.

16. The device of claim 14, wherein transmitting the data object to the requestor application system comprises:
generating metadata comprising abstract information of the data object based on the data object;
obtaining metadata associated with the data object from a metadata blockchain associated with the data object; and
transmitting the data object to the requestor application system in response to determining the generated metadata and the obtained metadata match each other.

17. The device of claim 16, wherein the operations further comprise:
in response to determining the generated metadata and the obtained metadata do not match each other, notifying the requestor application system that the data object has been modified.

18. The device of claim 17, wherein the operations further comprise:
notifying a further owner application system, where a copy of the data object is stored, to transmit the data object to the requestor application system.

19. The device of claim 11, wherein a copy record of the at least one copy record comprises a copy transaction for obtaining a copy of the data object.

20. A computer program product, tangibly stored on a non-transient computer readable medium and comprising machine executable instructions, which when executed by a processor, cause the processor to perform operations, the operations comprising:
receiving from a requestor application system a copy request for obtaining a copy of the data object;
obtaining at least one copy record associated with the data object from a group of copy records comprising in a copy blockchain associated with the data object;
determining a number of copies of the data object based on the at least one copy record; and
handling the copy request based on the determined number of the copies.
